(19) United States
(12) Patent Application Publication
(10) Pub. No.: US 2004/0140381 A1
(43) Pub. Date: Jul. 22, 2004

(54) Rock and stone tumbling apparatus

(76) Inventors: Brett M. Rose, Vancouver, WA (US); Michael A. Pauletto, Vancouver, WA (US)

Correspondence Address: MARK D. OLSON, OLSON & OLSON, 2400 S.W. 4th Avenue, Portland, OR, 97201, US

(21) Appl. No.: 10/613,579

(22) Filed: Jul. 2, 2003

Related U.S. Application Data
(60) Provisional application No. 60/393,711, filed on Jul. 3, 2002.

(51) Int. Cl. B02C 23/08

(52) U.S. Cl. 241/79.3

(57) ABSTRACT

A rock and stone tumbling apparatus is provided for mobile transport to desired sites for continuous, uninterrupted operation to repeatingly receive, load and tumble large amounts of raw stone materials in order to give them a worn, aged, weathered and decorative appearance, and then wash, size and discharge the tumbled stone product in sorted condition according to finished stone size, for the extremely efficient and cost effective large scale tumbling processing of rock and stone materials for use in landscaping, building and other industries.

This application claims benefit under 35 U.S.C. 119(e) of U.S. Provisional application Serial No. 60/393,711, filed 3 Jul. 2002.

### BACKGROUND OF THE INVENTION

This invention relates to rock and stone tumbling apparatus for the tumbling processing of large amounts of stone, and more particularly to a rock tumbler apparatus that is arranged to receive, load and tumble large amounts of raw stone materials in order to give them a worn, aged, weathered and decorative appearance, and then wash, size and discharge the tumbled stone product in sorted condition according to finish stone size for use of the finished stone product as decorative building and landscaping stone.

As is known, decorative stone is widely used for building facades, floors and other elements of building constructions and very widely used in the landscape industry in forms ranging from larger stones for rookeries and retaining walls down to small stone sizes used for ground cover for planting areas and walkways. Natural decorative stones can be quite expensive as is well known, and therefore the industry is endeavoring to utilize alternative decorative stone materials that are being manufactured to resemble and imitate naturally weathered decorative stones and the like. However, these too can be expensive, and do not necessarily well replicate naturally weathered and worn stone.

Apparatus for the large scale commercial tumbling processing of rock, stone and other materials has been provided heretofore as is illustrated in U.S. Pat. Nos. 5,586,925 (DiNorcia, S R. etal.); 2,912,803(Sinjian); and 1,946,440 (Herrmann) which each disclose tumbling apparatus representative of the structures heretofore known in the art. In each case, large cylindrical drums are provided with closed opposite longitudinal end walls which mount opposite, axially aligned pivot bearing supports configured to mount the tumbling drum rotatably therebetween on a supporting framework. Access panels are provided on the peripheral wall of the respective tumbling drums for access to the interior cavity of the drum for loading raw material into the drum and unloading finished, tumbled material from the drum.

As will be apparent to those skilled in the art, the loading and unloading of the tumbling drums of the first and last patent identified above requires that the drum be stopped for the accessing of the interior of the drum by personnel to physically remove the tumbled contents of the drum after each operation. The second identified patent provides a side wall access panel configured such that after tumbling, the drum may be stopped, the access panel manually opened, and the drum rotated to and stopped at a point at which the entire contents of the drum will simply fall out of the drum to the space therebelow, although this is merely an interpretation of the drawings and is not taught or suggested in the teachings of the patent.

### SUMMARY OF THE INVENTION

In its basic concept, this invention provides a rotating tumbling drum, open at one of its longitudinal ends for loading of raw stone material into the interior confines of the drum for tumbling operation and for discharging tumbled, finished stone out of the drum after tumbling operation, the finished stone product being discharged from the drum into sorted condition separated according to preselected finished stone sizes, all during continuous rotation of the tumbling drum.

It is by virtue of the foregoing basic concept that the principal objective of this invention is achieved; namely, the provision of a stone tumbling apparatus of the class described which overcomes the limitations and disadvantages of tumbling apparatus of the prior art.

Another object of this invention is the provision of a stone tumbling apparatus of the class described which also rinses the finished stone product during sizing and discharge from the tumbling drum.

Another object of this invention is the provision of a stone tumbling apparatus of the class described in which discharge of the stone from the tumbling drum is accomplished by tilting the rotating drum during rotation to move the stone being tumbled therein toward and out of the drum opening by continued rotation of the drum.

Another object of this invention is the provision of a stone tumbling apparatus of the class described which includes an associated drum loading apparatus to deliver a load of stone to be tumbled into the interior of the drum during rotation thereof.

Another object of this invention is the provision of a stone tumbling apparatus of the class described in which a water supply apparatus is arranged to deliver water into the tumbling drum during loading of the drum.

Still another object of this invention is the provision of a stone tumbling apparatus of the class described which may be mounted on a wheeled transport trailer so as to provide a substantially self-contained mobile tumbling apparatus arranged for transport to different sites for operation, thereby avoiding the heretofore necessary requirement and expense of shipping raw stone material to a dedicated processing site.

A further object of this invention is the provision of a stone tumbling apparatus of the class described which provides the industry with an acceptable, cost efficient decorative stone product that utilizes common, readily available materials including recycled materials normally not usable as decorative stone material including recycled or broken pieces of concrete slabs and blocks, bricks and common stones that can be made decorative and “weathered” with rounded edges by tumbling.

A further object of this invention is the provision of a stone tumbling apparatus of the class described which virtually eliminates physical handling of the stone and the apparatus throughout continued operations, thereby reducing labor expenses and enhancing personnel safety.

A still further object of this invention is the provision of a stone tumbling apparatus of the class described which is of simplified construction for economical manufacture, reliable operation, and simplified maintenance.

The foregoing and other objects and advantages of the present invention will appear from the following detailed description, taken in connection with the accompanying drawings of the preferred embodiment.

### BRIEF DESCRIPTION OF THE DRAWINGS

FIG. 1 is a fragmentary side elevation of a stone tumbling apparatus mounted on a mobile, wheeled trailer frame and embodying features of this invention, the apparatus shown in a stone discharge condition.

FIG. 2 is a fragmentary side elevation of the apparatus of FIG. 1 but showing the apparatus in a stone loading and tumbling condition of operation.

FIG. 3 is a fragmentary sectional view of the open end portion of the tumbling drum to show internal detail and illustrate the stone sizing structure and operation of the sizing ring members on the tumbling drum.

### DESCRIPTION OF THE PREFERRED EMBODIMENT

At the outset it is to be understood that, although the preferred embodiment of this invention is illustrated and disclosed herein as a mobile tumbler apparatus mounted on the bed of a truck-drawn, flatbed-type trailer, the apparatus may alternatively be mounted in fixed, stationary condition at a dedicated stone processing facility if desired. In such a case the base support structure illustrated herein as a road transport trailer 10 would instead be provided as a stationary base support structure for fixedly securing the apparatus on an underlying ground or floor surface.

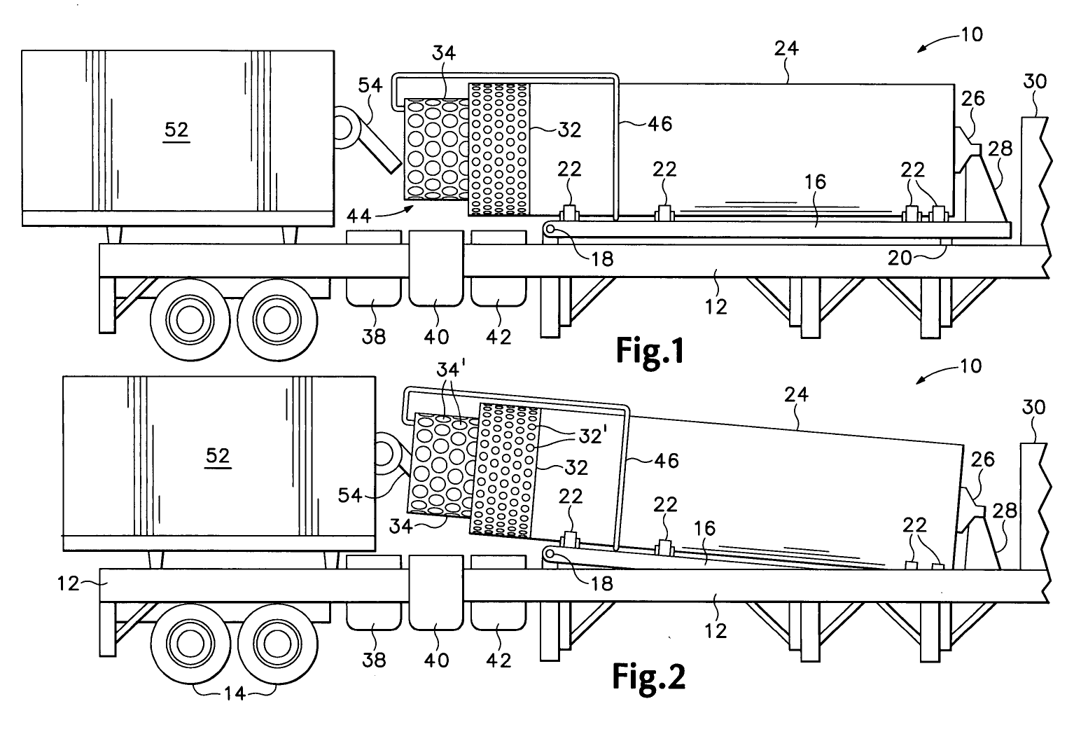

In the preferred embodiment illustrated however, a road transport trailer, shown here as a flatbed trailer 10 has, as typical, a longitudinally-extending framework 12 mounting transport wheels 14 adjacent its rear end and front end-supporting jack stands (not shown) adjacent its forward, truck-engaging hitch end (not shown), as is known in the industry. The framework 12 is configured to mount a generally rectangular drum-supporting tilt frame apparatus 16 which provides means for rotatably supporting a tumbler drum for longitudinal tilting movement on the trailer framework 12, as seen in viewing FIGS. 1 and 2 of the drawings. In this regard, the generally rectangular tilt frame apparatus 16 in this embodiment is mounted at one of its longitudinal ends to the frame of the trailer by pivot brackets 18 and at its opposite longitudinal end by powered tilt means such as hydraulic cylinders 20 which interconnect the trailer frame 12 and the tilt frame end for tilting movement of the frame about pivot mounting brackets 18, as is apparent in viewing FIGS. 1 and 2 of the drawings.

Bearing support means is provided to support a tumbling drum for rotation on the trailer frame. In this regard, the tilt frame apparatus 16 shown herein mounts a plurality of support rollers 22 along its opposite longitudinal sides, the support rollers arranged to support, in cradle-like manner, a large, generally cylindrical, hollow tumbler drum 24, open at its rear longitudinal end and supported for rotation on the rollers 22 as is apparent Powered drive means is provided for rotating the drum 24 on the support rollers 22. Although many various different arrangements may be provided for powered rotation of the tumbler drum 24, a variable speed hydraulic or electric drive 26 is mounted 28 on the tilt frame assembly 16 to engage the drum and rotate it at desired revolutions per minute on the supporting rollers 22. A hydraulic pump (not shown) and electric generator 30 are also provided on the trailer 10 along with a water pump and any necessary and desired controls, etc. as may be needed for operation of the various equipment of the trailer-mounted apparatus of this invention as will become clear from the following.

Preferably, means is provided for sorting the tumbled material being discharged from the drum by separating the material according to its size. In the embodiment shown herein, the drum mounts on its rear, open longitudinal end, at least one stone sizing ring member 32 arranged to extend rearwardly from the drum in opening-encircling condition as shown. The ring member 32 is provided with a plurality of stone sizing openings 32′ therethrough, the diameter of the openings being selected to permit stones of a certain diameter and smaller to fall therethrough for reasons which will be explained later. In the embodiment illustrated, a second, inner sizing ring member 34 is mounted to the drum inwardly of and projecting further rearwardly from the first ring member 32, the ring member 34 being provided with a plurality of stone sizing openings 34′ having a larger diameter than openings 32′ through which stones having an equal or smaller diameter can pass through. Clearly, stones capable of passing through the openings 32′ will easily have first fallen through the larger openings 34′.

In the preferred form shown herein, the ring member 34 is mounted to the drum by a radially projecting flange member 36 which provides a wall surface that forms a step or ledge which prevents passage of a portion of the remaining sand and fines F out of the drum during discharge of a load of tumbled stone material as will be explained. These fines are preferably retained in the drum for use as abrasive material in the next and subsequent tumbling operations of the drum, and they also serve to protect and cushion the drum itself against scraping and impact damage by the larger tumbling stone material during the tumbling process.

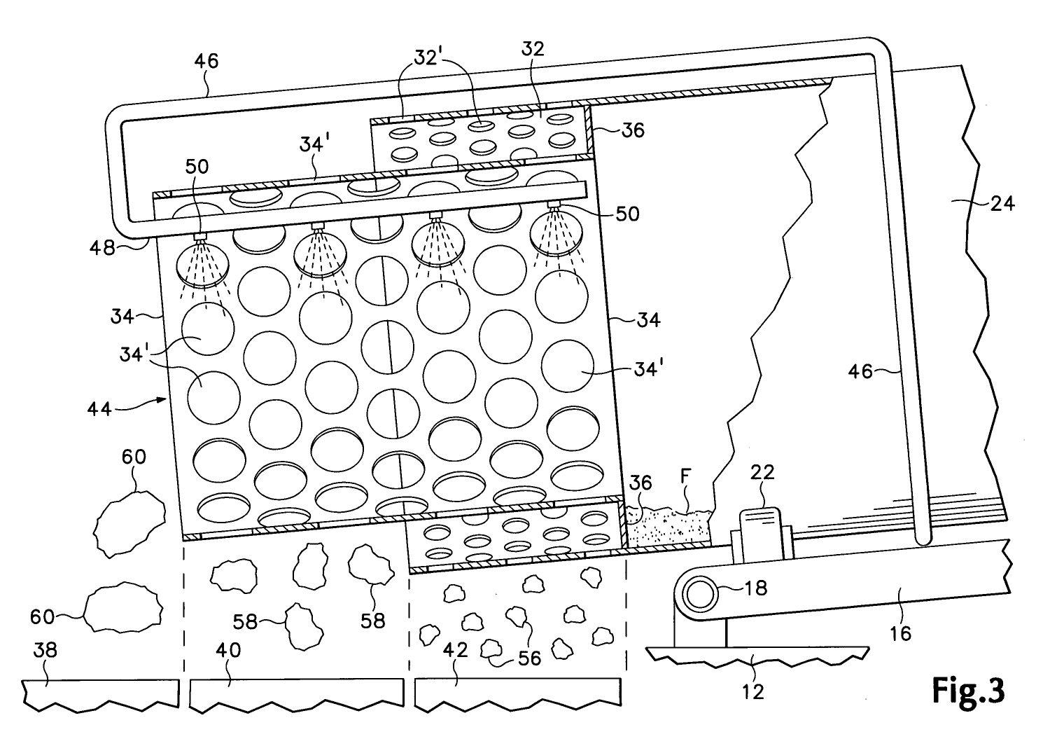

Positioned on the frame 12 beneath the outfeed of the drum and the ring members 34, 32 are, in this embodiment, three discharge chute members 38, 40, 42 arranged to catch stone material falling through the openings 32′, 34′ in the ring members 32, 34 and out the central opening 44 of the ring member 34. As indicated in FIGS. 1 and 2, during discharging of tumbled stone from the drum after tumbling, these discharge chute members, which may be electrically or hydraulically driven conveyors if desired, are arranged to deliver stones falling thereonto laterally outwardly to convenient discharge points alongside the trailer as finished stone product sorted by size as will be understood in viewing FIG. 3 of the drawings and as will be described later.

As shown, a high pressure spray wash line 46 is provided for connection (not shown) to a trailer-mounted water pump or other outside source of water under pressure, the spray wash line configured with a terminal end portion 48 arranged to extend into the rear central opening 44 of the ring assembly. As best seen in FIG. 3 of the drawings, the water line portion 48 is positioned preferably adjacent the uppermost portion of the ring member 34 so as to leave as much of the interior confines of the ring members free of obstruction as possible. Spray nozzles 50 are positioned along the terminal end portion 48 so that substantially all of the interior working length of the sizing rings 32, 34 may receive a water spray therefrom. This terminal end portion 48 may extend further into the hollow interior confines of the drum itself if desired to provide a source of water to the interior of the drum for use in the tumbling operation.

Mounted on the frame 12 rearward of the central opening 44 of the drum is a feed hopper 52 arranged for electrically or hydraulically driven longitudinal carriage movement on the frame 12 between a first retracted position seen in FIG. 1 and a second, extended position as seen in FIG. 2. The feed hopper is configured to receive and hold a load of raw stone material, as for example delivered by a front end loader or other suitable type of equipment. The interior of the hopper is configured to deliver stone material contained in the hopper to an electrically or hydraulically driven conveyor apparatus having a forwardly projecting discharge end 54 arranged to extend into the drum opening 44 when the hopper is moved into said second, extended position. In this position the conveyor apparatus may be operated to move the contents of the hopper into the hollow confines of the drum.

With the foregoing basic structure of the stone tumbling apparatus of this invention thus now described, the operation of the preferred embodiment of the invention illustrated herein is as follows:

With the tumbler apparatus set up at a work site, connected to a supply of water and placed in the condition of FIG. 1 and having completed the discharge of a load of tumbled stone from a previous tumbling operation, the hydraulic cylinder 20 is operated to pivot the drum tilt frame 16 downward, placing the drum into the lowered, downwardly tilted condition of FIG. 2. The feed hopper carriage is then operated to move the loaded feed hopper 52 forward into its extended condition in which the outfeed end of the hopper conveyor 54 extends into the confines of the drum as also seen in FIG. 2. The drum drive means 26 is operated to rotate the drum, and the conveyor 54 is operated to convey the raw stone material from the hopper through the opening 44 and into the confines of the rotating drum. As the drum is being filled with the raw stone material, water is simultaneously being introduced into the drum, and the rotation of the downwardly tilting drum facilitates the movement of the raw stone material toward the opposite, lower end of the drum. Once the drum has been filled with raw stone material from the hopper, the speed of the rotation of the drum is selected to give the desired tumbling effect of the stone, and the tumbler is left to run continuously until the desired finish on the stone is achieved, typically one-half hour to one hour in duration. Different types of stone material will require different amounts of tumble time and rotation speed in order to achieve the desired effect.

When a desired tumbling operation has been completed, the feeder hopper assembly is moved into its first, retracted condition of FIG. 1 and may be re-loaded with raw stone material from a front end loader or other suitable equipment in preparation for the next tumbling operation. The hydraulic cylinder 20 is operated to raise the tilt frame 16, placing the drum in the raised, discharge condition of FIGS. 1 and 3, whereupon continued rotation of the drum causes the stone material contained therein to move out of the drum through the central opening 44 formed by the ring member 34 as seen best in FIG. 3 of the drawings. As will be understood, during the tumbling operation, as the stone tumbles, small pieces chip off of the stones and create fines which serve well as a grinding or smoothing compound during the tumbling operation. During the discharge operation, because of the ledge 36 configuration at the open end of the drum, much of these fines remain trapped in the interior of the drum for use in subsequent tumbling operations.

As the tumbled stone product exits the drum through the center opening 44 of the ring member 34, small stones, fines and water immediately pass through the larger sizing openings 34′ onto the inner surface of ring member 32 and, thence through the smaller openings 32′ if the material is small enough to pass therethrough. In this manner, small stones 56, sand-like fines and water are able to pass directly to discharge chute 42 as waste and smallest size tumbled stone material. Stone material having passed through openings 34′ but are too large to pass through openings 32′ are moved rearwardly and out of the space between the ring members 32, 34 and fall, together with stones 58 of a size able to fall through openings 34′ downward onto a second discharge chute 40 as a mid-size stone product.

Finally, stones 60 that are larger than the sizing openings 34′ are simply carried along the inner surface of the ring member 34 whereupon they ultimately fall out of the central opening 44 and onto a third discharge chute 38 or conveyor as a third, larger size finished stone product. Accordingly, all of the finished stone material is delivered to preselected discharge points alongside the trailer apparatus in sorted condition according to finished stone size. As the stone material passes from the drum member through the ring members 32, 34, a high pressure spray wash provided by nozzles 50 cleans the stone product of fines and other materials as they pass through the ring assembly and prior to their being delivered to their various sort piles. Accordingly, with raw stone material being dumped into the hopper in bulk by a front end loader or the like, the apparatus of this invention not only provides tumbled, finish stones as an end product, but provides stones that have been washed, sized and delivered out of the apparatus to discharge locations sorted by stone size without any manual handling of the stone material.

From the foregoing it will be apparent to those skilled in the art that various changes other than those already discussed may be made to the size, shape, type, number and arrangement of parts described hereinbefore without departing from the spirit of this invention and the scope of the appended claims.

Having described our invention in the manner in which it may be used, we claim:

1. A tumbling apparatus for the tumbling processing of large amount of individual, irregularly shaped raw materials having non-uniform, different overall individual sizes including rock and stone into a finished, tumbled condition, the tumbling apparatus comprising:
a) a base frame configured for disposition on an underlying surface,
b) a substantially hollow tumbling drum supported on said base frame for rotation thereon,
c) said tumbling drum having a peripheral side wall and opposite longitudinal ends defining therebetween an interior tumbling drum cavity, one of said opposite longitudinal ends forming a drum opening for passage of raw material therethrough into said drum cavity during rotation of the drum and for passage of tumbled material therethrough out of said drum cavity during rotation of said drum,
d) power drive means for rotating said tumbling drum supported on said base frame,
e) means for communicating raw material to be tumbled in a first direction through said drum opening into said drum cavity during rotation of said tumbling drum on said base frame, and
f) means for discharging finished tumbled material from said drum cavity in a second, opposite direction through said drum opening during rotation of said tumbling drum on said base frame.

2. The tumbling apparatus of claim 1 including sorting means communicating with said drum opening for receiving tumbled material discharged in said second, opposite direction through said drum opening during rotation of said tumbling drum and sorting the material for separated discharge of individual material having a first predetermined size range to a first discharge destination, and discharge of individual material having a second, larger size range to a second, separate discharge destination.

3. The tumbling apparatus of claim 2 wherein said sorting means comprises a substantially cylindrical, perforate sizing ring member open at its opposite longitudinal ends and secured at one longitudinal end to said tumbling drum in position encircling and extending said drum opening, said sizing ring member formed with a plurality of sizing openings having a predetermined diameter, whereby material discharged in said second direction through the drum opening during rotation of the drum moves through and along said sizing ring member rotating therewith, material in said first size range falling through the sizing openings to a first discharge destination and material in said second, larger size range moving through the sizing ring member and out of its open longitudinal end to a second, separate discharge destination.

4. The tumbling apparatus of claim 3 including pressure spray wash means for rinsing the finished, tumbled material discharged through said drum opening as the material moves through and along said sizing ring member.

5. The tumbling apparatus of claim 1 wherein said means for discharging tumbled material from the drum cavity includes a powered tumbling drum tilt frame rotatably supporting the tumbling drum on the base frame and operable to tilt the tumbling drum rotating on the base frame between a first, loading and tumbling position in which the rotating drum is tilted so that material tumbling in the drum cavity cannot move out of the drum cavity through said drum opening during rotation of the drum, and a second, discharge position in which the rotating tumbling drum is tilted so that material tumbling in the drum cavity moves toward and through said drum opening during rotation of the tumbling drum.

6. The tumbling apparatus of claim 1 wherein said means for communicating raw material into the drum cavity comprises a feed conveyor having an outfeed end movable into registry with said drum opening for conveying raw material in said first direction therethrough into said drum cavity during rotation of said tumbling drum.

7. The tumbling apparatus of claim 6 wherein said feed conveyor is mounted on and communicates with the interior of a feed hopper mounted on said base frame for movement toward and away from said tumbling drum for moving said outfeed end of the feed conveyor into registry with said drum opening for conveying raw material contained in the feed hopper to the drum cavity for tumbling, and moving the outfeed end of the feed conveyor out of registry with the drum opening during discharge of tumbled material through the drum opening and for refilling of the feed hopper with raw material for subsequent conveying to the drum cavity.

8. The tumbling apparatus of claim 1 wherein said base frame is configured as a mobile transport vehicle having ground-engaging wheels for supporting the vehicle for transport along underlying road surfaces.

9. A tumbling apparatus for the tumbling processing of large amount of individual, irregularly shaped raw materials having non-uniform, different overall individual sizes including rock and stone into a finished, tumbled condition, the tumbling apparatus comprising:
a) a base frame configured for disposition on an underlying surface,
b) a substantially hollow tumbling drum supported on said base frame for rotation thereon,
c) said tumbling drum having a peripheral side wall and opposite longitudinal ends defining therebetween an interior tumbling drum cavity, one of said opposite longitudinal ends forming a drum opening for passage of raw material therethrough into said drum cavity during rotation of the drum and for passage of tumbled material therethrough out of said drum cavity during rotation of said drum,
d) power drive means for rotating said tumbling drum supported on said base frame,
e) means for communicating raw material to be tumbled in a first direction through said drum opening into said drum cavity during rotation of said tumbling drum on said base frame, and
f) tumbling drum tilt means for longitudinally tilting the tumbling drum member during rotation on the base frame between a first, loading and tumbling position in which the rotating drum is tilted so that material tumbling in the drum cavity cannot move out of the drum cavity through said drum opening during rotation of the tumbling drum, and a second, discharge position in which the rotating tumbling drum is tilted so that material tumbling in the drum cavity moves toward and through said drum opening during rotation of the tumbling drum.

10. The tumbling apparatus of claim 9 including sorting means communicating with said drum opening for receiving tumbled material discharged in said second, opposite direction through said drum opening during rotation of said tumbling drum and sorting the material for separated discharge of individual material having a first predetermined size range to a first discharge destination, and discharge of individual material having a second, larger size range to a second, separate discharge destination.

11. The tumbling apparatus of claim 10 wherein said sorting means comprises a substantially cylindrical, perforate sizing ring member open at its opposite longitudinal ends and secured at one longitudinal end to said tumbling drum in position encircling and extending said drum opening, said sizing ring member formed with a plurality of sizing openings having a predetermined diameter, whereby material discharged in said second direction through the drum opening during rotation of the drum moves through and along said sizing ring member rotating therewith, material in said first size range falling through the sizing openings to a first discharge destination and material in said second, larger size range moving through the sizing ring member and out of its open longitudinal end to a second, separate discharge destination.

12. The tumbling apparatus of claim 11 including pressure spray wash means for rinsing the finished, tumbled material discharged through said drum opening as the material moves through and along said sizing ring member.

13. The tumbling apparatus of claim 11 wherein said means for communicating raw material into the drum cavity comprises a feed conveyor having an outfeed end movable into registry with said drum opening for conveying raw material in said first direction therethrough into said drum cavity during rotation of said tumbling drum.

14. The tumbling apparatus of claim 13 wherein said feed conveyor is mounted on and communicates with the interior of a feed hopper mounted on said base frame for movement toward and away from said tumbling drum for moving said outfeed end of the feed conveyor into registry with said drum opening for conveying raw material contained in the feed hopper to the drum cavity for tumbling, and moving the outfeed end of the feed conveyor out of registry with the drum opening during discharge of tumbled material through the drum opening and for refilling of the feed hopper with raw material for subsequent conveying to the drum cavity.

15. The tumbling apparatus of claim 9 wherein said means for communicating raw material into the drum cavity comprises a feed conveyor having an outfeed end movable into registry with said drum opening for conveying raw material in said first direction therethrough into said drum cavity during rotation of said tumbling drum.

16. The tumbling apparatus of claim 15 wherein said feed conveyor is mounted on and communicates with the interior of a feed hopper mounted on said base frame for movement toward and away from said tumbling drum for moving said outfeed end of the feed conveyor into registry with said drum opening for conveying raw material contained in the feed hopper to the drum cavity for tumbling, and moving the outfeed end of the feed conveyor out of registry with the drum opening during discharge of tumbled material through the drum opening and for refilling of the feed hopper with raw material for subsequent conveying to the drum cavity.

17. The tumbling apparatus of claim 9 wherein said base frame is configured as a mobile transport vehicle having ground-engaging wheels for supporting the vehicle for transport along underlying road surfaces.
